(19) United States
(12) Patent Application Publication
(10) Pub. No.: US 2023/0287635 A1
(43) Pub. Date: Sep. 14, 2023

(54) METHOD AND SYSTEM FOR OPERATING COMPACTION MACHINES

(71) Applicant: Caterpillar Paving Products Inc., Brooklyn Park, MN (US)

(72) Inventor: Brian Nagel, Ramsey, MN (US)

(73) Assignee: Caterpillar Paving Products Inc., Brooklyn Park, MN (US)

(21) Appl. No.: 17/654,446

(22) Filed: Mar. 11, 2022

(51) Int. Cl. E01C 19/28

(52) U.S. Cl. CPC E01C 19/288

(57) ABSTRACT

A method for operating a compaction machine is disclosed. The method includes monitoring, by a traction sensing device, a front traction associated with a front driving member. The method further includes monitoring, by the traction sensing device, a rear traction associated with a rear driving member, the front driving member and the rear driving member being propelled through at least one motor. The method further includes comparing, by a controller coupled to the traction sensing device, the front traction with the rear traction to obtain a compared traction. The method further includes identifying, by the controller, a condition in which one of the front driving member or the rear driving member spins higher than the other when the compared traction exceeds a predefined threshold traction.

### TECHNICAL FIELD

The present disclosure relates generally to asphalt and soil compacting work machines, such as compaction machines, and, more particularly, to methods and systems to determine a condition in which a compaction drum of a compaction machine slips relative to a surface.

### BACKGROUND

Compaction machines are commonly employed for compacting earth, freshly laid asphalt, soil, and other similar compactable substrates to form a road surface along an expanse of a roadway. In this regard, compaction machines generally include one or more compactor drums and one or more traction devices. During a compaction operation, a compactor drum typically comes into contact with and rolls against an underlying compactable substrate to push down and provide compaction to the compactable substrate, while the traction devices provide traction against a surface so as to move the compaction machine relative to the surface such that as the machine is driven, the compaction operation may be performed.

A degree of traction offered by the compactor drum and the traction devices against any surface are generally different. Such a difference can be compounded based on factors, such as the type of surface, inclination of the surface, etc., over which the compaction machine may travel or be driven.

U.S. Pat. No. 8,020,659 relates to hydrostatically driven vehicles and to diagnostic systems and controls monitoring operation of hydraulic circuits operating to propel said type of vehicles. The hydrostatically driven vehicle has an engine operating a variable displacement propel pump, a displacement of which can vary based on an angle of a rotating swashplate, such that a fluid flow impelled by the pump transfers power to at least one propel motor rotating a wheel of the vehicle. An electronic controller of the vehicle senses an operating parameter of the system, for example, the angle of the rotating swashplate or the direction and speed of rotation of the propel motor with a sensor to yield an actual signal, and relays the actual signal to an electronic controller. The controller determines a desired angle for the rotating swashplate based on the control signal, and compares it to the actual signal from the sensor. Motion of the vehicle is stalled when the angle signal differs from the desired angle by a predetermined extent and for a predetermined period.

### SUMMARY OF THE INVENTION

In one aspect, the disclosure is directed to a method for operating a compaction machine. The method includes monitoring, by a traction sensing device, a front traction associated with a front driving member. The method further includes monitoring, by the traction sensing device, a rear traction associated with a rear driving member. The front driving member and the rear driving member being propelled through at least one motor. The method further includes comparing, by a controller coupled to the traction sensing device, the front traction with the rear traction to obtain a compared traction. The method further includes identifying, by the controller, a condition in which one of the front driving member or the rear driving member spins higher than the other when the compared traction exceeds a predefined threshold traction.

In another aspect, the disclosure is directed to system for operating a compaction machine. The system includes a traction sensing device configured to monitor a front traction associated with front driving member and a rear traction associated with a rear driving member of the compaction machine. The front driving member and the rear driving member being propelled through at least one motor. The system further includes a controller coupled to the traction sensing device. The controller is configured to compare the front traction with the rear traction to obtain a compared traction, and identify a condition in which one of the front driving member or the rear driving member spins higher than the other when the compared traction exceeds a predefined threshold traction.

In yet another aspect, the disclosure is directed to a compaction machine. The compaction machine includes a frame mounted on a front driving member and a rear driving member. The compaction machine further includes a traction sensing device configured to monitor a front traction associated with front driving member and a rear traction associated with a rear driving member of the compaction machine. The front driving member and the rear driving member being propelled through at least one motor. The compaction machine further includes a controller coupled to the traction sensing device. The controller is configured to compare the front traction with the rear traction to obtain a compared traction, and identify a condition in which one of the front driving member or the rear driving member spins higher than the other when the compared traction exceeds a predefined threshold traction.

### BRIEF DESCRIPTION OF THE DRAWINGS

FIG. 1 is a perspective view of a compaction machine, in accordance with an aspect of the present disclosure;

FIG. 2 is a schematic view of a system for operating compaction machine of FIG. 1, in accordance with an aspect of the present disclosure;

FIG. 3 is a schematic view of a system for operating a compaction machine of FIG. 1, in accordance with another aspect of the present disclosure;

FIGS. 4, 5, and 6 illustrate a scenario associated with a loading of the compaction machine of FIG. 1 on to a trailer, in accordance with an aspect of the present disclosure; and

FIG. 7 is an exemplary flowchart that illustrates a method for operating a compactor drum of the compaction machine, in accordance with an aspect of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts, e.g., 1, 1′, 1″, 101 and 201 could refer to one or more comparable components used in the same and/or different depicted embodiments.

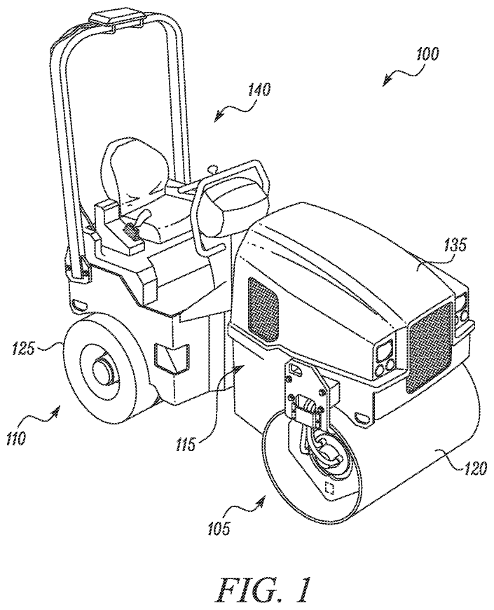

Referring to FIG. 1, a compaction machine 100 is shown. The compaction machine 100 may be an earth compactor which can be of vibratory type or of non-vibratory type. The compaction machine 100 may be a soil compactor or an asphalt compactor. Although the compaction machine 100 is described, one or more aspects of the present disclosure may be suitably applied or extended to various other machines, such as excavators, loaders, graders, pavers, and the like.

The compaction machine 100 includes a front driving member 105 and a rear driving member 110. The compaction machine 100 further includes a frame 115 supported on the front driving member 105 and the rear driving member 110. The front driving member 105 may be a compactor drum 120 which may be used for compacting material such as soil, asphalt, etc. The compactor drum 120 may be a steel drum or may be formed from steel, such that an outer surface contacting a compactable material, may be formed from steel. The rear driving member 110 may include a pair of wheels 125 that may be interconnected to each other by an axle (not shown). Alternatively, the rear driving member 110 may include a compactor drum similar to the compactor drum 120.

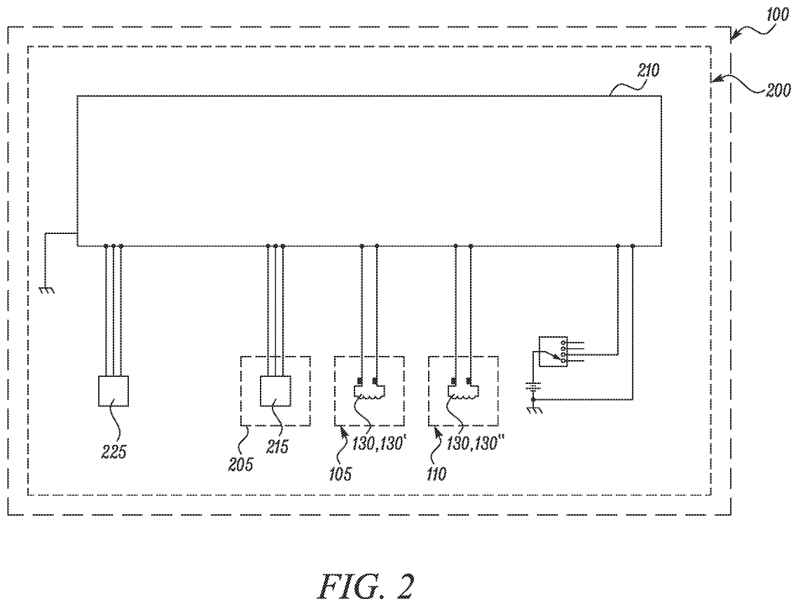

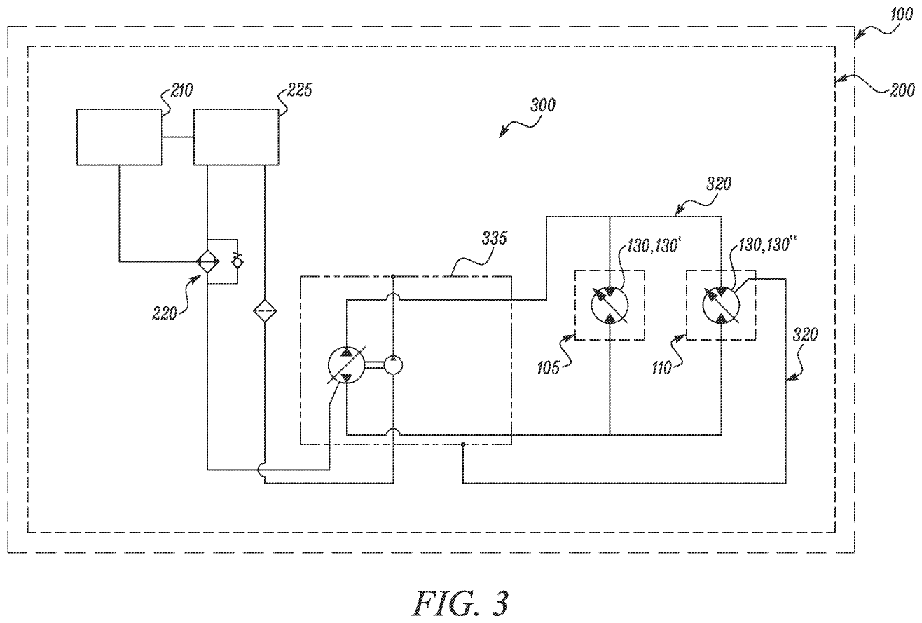

Referring to FIGS. 2 and 3, the front driving member 105 and the rear driving member 110 may be each powered by at least one motor 130 (e.g., a front driving motor 130′ and a rear driving motor 130″). The front driving motor 130′ and the rear driving motor 130″ may respectively impart motion to the front driving member 105 and the rear driving member 110 to help propel the compaction machine 100 in either of a forward or rearward direction. In some embodiments, as shown in FIG. 3, the front driving motor 130′ may be a hydraulic motor for rotating the compactor drum 120, and the rear driving motor 130″ may be a hydraulic motor for rotating the wheels 125. Alternatively, as shown in FIG. 2, the front driving motor 130′ and the rear driving motor 130″ may be electrically powered motors.

Referring back to FIG. 1, the compaction machine 100 may include power source system 135 such as an engine. The engine may be powered by any fuel, such as a gasoline, diesel, natural gas, or hybrid-powers engine, or a combination of these. It is contemplated, however, that in some embodiments, the power source 135 may include an electrical power source. Said electric power source may function either alone or in combination with the engine. The power source system 135 may be configured to deliver rotational power output to the front driving motor 130′ and the rear driving motor 130″ respectively associated with the front driving member 105 and the rear driving member 110. The power source system 135 may also be configured to deliver power to operate one or more other components or accessory devices (e.g. pumps, fans, motors, generators, belt drives, transmission devices, etc.) associated with the compaction machine 100.

The compaction machine 100 may include an operator station 140. In some embodiments, the operator station 140 may station one or more operators of the compaction machine 100 to control a functioning of the compaction machine 100. The operator station 140 may include one or more controls, which may be used by an operator to operate and/or control the compaction machine 100. The controls may include one or more input devices, which may take the form of buttons, switches, sliders, levers, wheels, touch screens, displays, or other input/output or interface devices, accessing one or more of which may enable operators of the compaction machine 100 to gain knowhow and/or control of various parameters and functioning of the compaction machine 100.

Referring to FIG. 2, a system 200 for operating the compactor drum 120 of the compaction machine 100 is described. The system 200 includes a traction sensing device 205, a controller 210, and a traction control device 225. In an embodiment, the controller 210 and the traction control device 225 are separate components and may be communicably coupled to each other over a wired or wireless network. Alternatively, the controller 210 and the traction control device 225 may be integrated with each other.

The traction sensing device 205 is configured to monitor a front traction associated with the front driving member 105 and a rear traction associated with the rear driving member 110 of the compaction machine 100. In an embodiment as shown in FIG. 2, the traction sensing device 205 includes at least one speed sensor 215 configured for monitoring rotational speed of the front driving motor 130′ and the rear driving motor 130″. In some embodiments, the front driving motor 130′ and the rear driving motor 130″ may be provided with dedicated speed sensors. The speed sensor 215 senses rotational speed of the front driving motor 130′ and the rear driving motor 130″ and generates a speed signal proportional thereto.

Referring to FIG. 3, a system 200 for operating the compactor drum 120 of the compaction machine 100 in another aspect is described. In this embodiment, the traction sensing device 205 includes at least one pressure sensor 220 configured for monitoring hydraulic pressure associated with supply and return hydraulic lines 320 of the front driving motor 130′ and the rear driving motor 130″. The pressure sensor 220 senses hydraulic pressure of the front driving motor 130′ and the rear driving motor 130″ and generates a pressure signal proportional. In an exemplary embodiment, the traction sensing device 205 of the system 200 may be configured with both the speed sensor 215 and the pressure sensor 220.

Referring to FIGS. 2 and 3, the controller 210 is communicably coupled to the traction sensing device 205 and is configured for receiving and processing the speed signals from the speed sensor 215 and/or the pressure signals from the pressure sensor 220. In an example, the controller 210 may be configured to receive inputs, data, and/or signals from the one or more input devices, and or other sensors associated with the compaction machine 100 and to control the operation of one or more components (e.g., front driving member 105, rear driving member 110, at least one motor 130, engine 135, etc.). In an embodiment, the controller 210 receives and processes the speed signal and/or the pressure signal indicative of rotational speeds of the front driving motor 130′ and the rear driving motor 130″. The controller 210 further evaluates corresponding tractions associated with the front driving member 105 and the rear driving member 110. The traction is generally indicative of rotational speeds of the front driving motor 130′ and the rear driving motor 130″ vis-à-vis friction offered by the surface in contact.

Referring to FIGS. 2 and 3, the traction control device 225 is operatively coupled with the controller 210 and is configured for controlling traction associated with at least one of the front driving member 105 and the rear driving member 110 based upon one or more instructions received from the controller 210. In the embodiment of FIG. 2, the traction control device 225 is configured to operate a torque control means for varying the torque applied by the front driving motor 130′ and the rear driving motor 130″. The torque control means is a conventional electronic torque control means for varying the torque applied by the front driving motor 130′ and the rear driving motor 130″. The traction control device 225 may control the torque by varying a hydraulic displacement or stroke associated with the front driving motor 130′ and the rear driving motor 130″. Alternatively in the embodiment of FIG. 3, the traction control device 225 may control the torque by manipulating a hydraulic pressure associated with the supply and return hydraulic lines 320 of the front driving motor 130′ and the rear driving motor 130″. Varying the torque applied by the front driving motor 130′ and the rear driving motor 130″ varies the rotational speed of the front driving member 105 (i.e., the compactor drum 120) and the rear driving member 110 (i.e., the wheels 125).

Referring to the embodiment of FIG. 3, a hydraulic circuit 300 configured with the system 200 is shown. The hydraulic circuit 300 is associated with the front driving motor 130′ and the rear driving motor 130″. The hydraulic circuit 300 includes the at least one pressure sensor 220 configured for monitoring the hydraulic pressure associated with the front driving motor 130′ and the rear driving motor 130″. In this embodiment, the at least one pressure sensor 220 is installed in supply and return hydraulic lines 320 of the front driving motor 130′ and the rear driving motor 130″. In this embodiment, the hydraulic circuit 300 includes a flow divider 335. The flow divider 335 is operatively coupled to the traction control device 225. The flow divider 335 is configured to split hydraulic fluid flow in the supply and return hydraulic lines 320 of the front driving motor 130′ and the rear driving motor 130″ into front and rear flows where each flow is directed to the particular driving motor 130′, 130— in order to power it.

### INDUSTRIAL APPLICABILITY

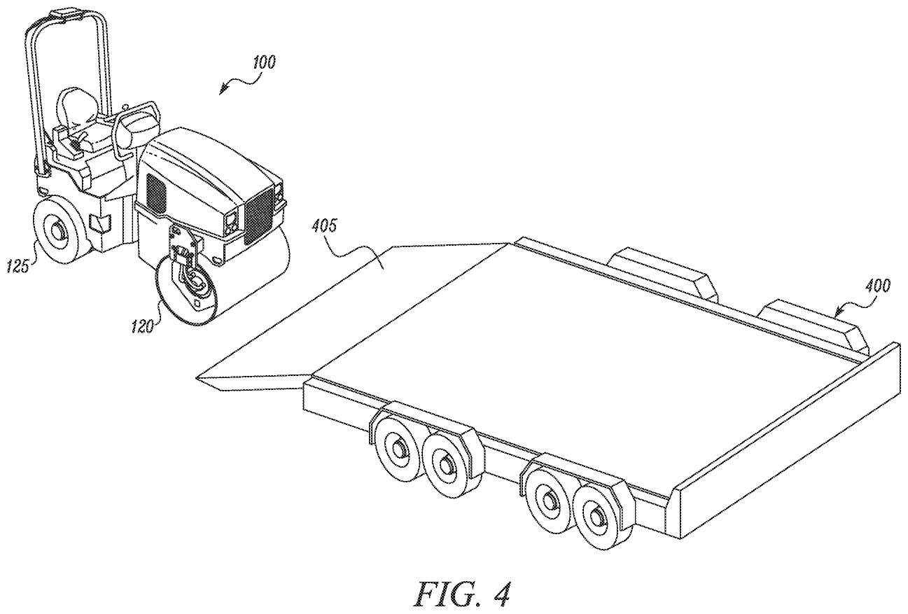

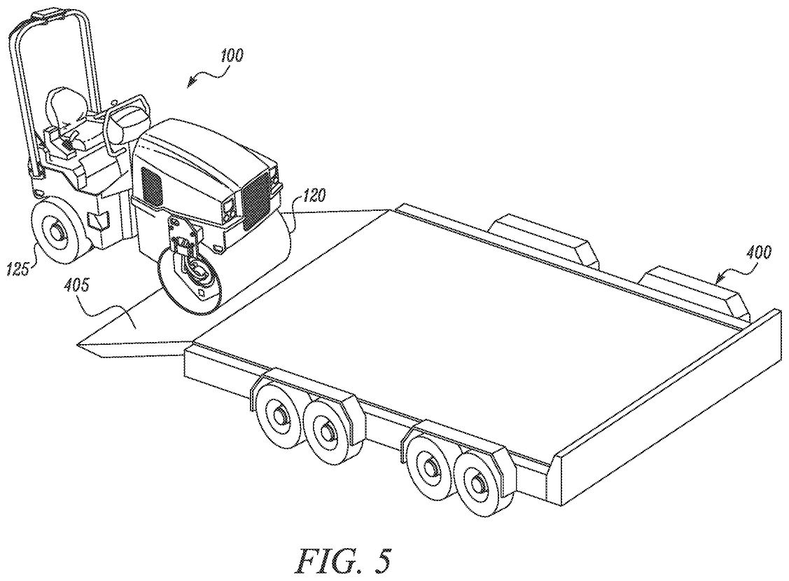

Referring to FIGS. 4 to 6, a scenario associated with loading of the compaction machine 100 over a trailer 400 is shown for a transportation of the compaction machine 100 from one location to another location. For achieving such loading, a ramp 405 may be positioned between a surface portion where the compaction machine 100 is stationed and the bed of the trailer 400. Then, the compaction machine 100 may be made to climb over an inclined ramp 405 of the trailer 400. As the compaction machine 100 moves over the ramp 405, a traction associated with the front driving member 105 and the rear driving member 110 may change or differ. Such a difference may primarily arise because of the surface of the ramp 405 in contact with the front driving member 105 and the rear driving member 110. For example, the type of surface on ground may offer more friction as against a metallic surface of the ramp 405 that offers less friction. Another important factor is inclination of the ramp 405.

Referring to FIGS. 1-6 collectively, as the operator drives the compaction machine 100 over the ramp 405, the traction sensing device 205 monitors the front traction associated with the front driving member 105 and the rear traction associated with the rear driving member 110. In this regard, the speed sensor 215 provides the speed signals corresponding to respective rotational speeds of the front driving motor 130′ and the rear driving motor 130″ to the controller 210 for evaluating corresponding tractions. In another embodiment, the pressure sensor 220 provides the pressure signals corresponding to respective hydraulic pressures associated with the front driving motor 130′ and the rear driving motor 130″ to the controller 210 for evaluating corresponding tractions. In this embodiment, the hydraulic pressures are indicative of respective rotational speeds of the front driving motor 130′ and the rear driving motor 130″.

Further, the controller 210 receives inputs from the traction sensing device 205 and compares the front traction with the rear traction to obtain a compared traction. In an embodiment, the traction associated with either the front driving member 105 or the rear driving member 110 is indicative of spinning of the front driving member 105 or the rear driving member 110 relative to the ramp 405, i.e., rotational speeds of the front driving motor 130′ and the rear driving motor 130″ vis-à-vis friction offered by surface of the ramp 405 in contact. When both the front driving member 105 or the rear driving member 110 are experiencing traction, the controller 210 evaluates the compared traction based upon the rotational speed of motors 130′ and 130″. In case, the compared traction is within a predefined threshold traction, the controller 210 identifies an optimum working condition for the motors 130′ and 130″. Further, in an embodiment, the controller 210 is configured to identify a condition in which one of the front driving member 105 or the rear driving member 110 spins higher than the other or is slipping with respect to the other due to loss of sufficient friction offered by surface of the ramp 405. When either the front driving member 105 or the rear driving member 110 are slipping, the speed of the slipping member increases. In case, the condition is identified, the controller 210 generates an alert signal indicating that the compared traction has exceeded the predefined threshold traction.

In an embodiment, a notification corresponding to the alert signal may be made available to the operator on displays, or other input/output or interface devices of the compaction machine 100 in the operator station 140 to make the operator aware of the condition associated with the compaction machine 100. In an embodiment, the condition is indicative of a slipping of the compaction machine 100 while movement over the ramp 405. Accordingly, the operator activates the traction control device 225. In an alternative embodiment, the traction control device 225 may be activated by the controller 210 with or without any intimation to the operator. In another alternative embodiment, the traction control device 225 may be activated by the controller 210 in case the operator fails to respond to the notification within a predefined time.

As the controller 210 detects that the compared traction has exceeded the predefined threshold traction, and the traction control device 225 is activated, the traction control device 225 lowers the torque applied by the motor 130′ or 130″ to the slipping member until the compared traction comes within the range of predefined threshold traction. In an embodiment, the traction control device 225 is configured for selectively and independently controlling the front driving motor 130′ and the rear driving motor 130″ for controlling traction associated with at least one of the front driving member 105 and the rear driving member 110 based upon the alert signal generated by the controller 210.

In an embodiment, based upon the inputs from the speed sensors 215, and instructions from the controller 210, the traction control device 225 reduces the hydraulic displacement or stroke associated with either of the front driving motor 130′ and the rear driving motor 130″, to control and reduce the rotational speed of the high spinning motor to regain traction.

In an alternative embodiment, based upon inputs from the pressure sensor 220, and instructions received from the controller 210, the traction control device 225 controls the flow divider 335 associated with the hydraulic circuit 300. In this embodiment, the flow divider 335 is configured to divert hydraulic fluid flow among either of the front driving motor 130′ and the rear driving motor 130″, to control and reduce the rotational speed of the high spinning motor 130′ or 130″ to regain traction.

In yet another alternative embodiment, the traction sensing device 205 may employ both the speed sensors 215 and the pressure sensor 220 for providing inputs to the controller 210 for evaluating the compared traction. Further in this embodiment, the traction control device 225 may simultaneously reduce the hydraulic displacement or stroke associated with either of the front driving motor 130′ and the rear driving motor 130″ and control the flow divider 335 to divert hydraulic fluid flow among either of the front driving motor 130′ and the rear driving motor 130″, to control and reduce the rotational speed of the high spinning motor to regain traction.

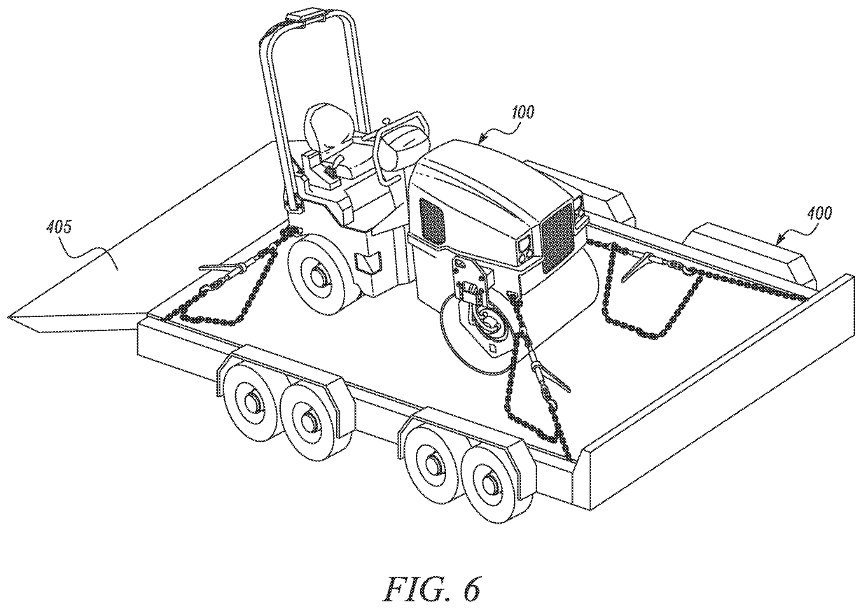

Accordingly, while climbing upon the ramp 405 of the trailer 400, the system 200 controls and regains traction associated with the front driving member 105 and/or the rear driving member 110 such that the compaction machine 100, as shown in FIG. 6, is safely loaded on to the trailer 400.

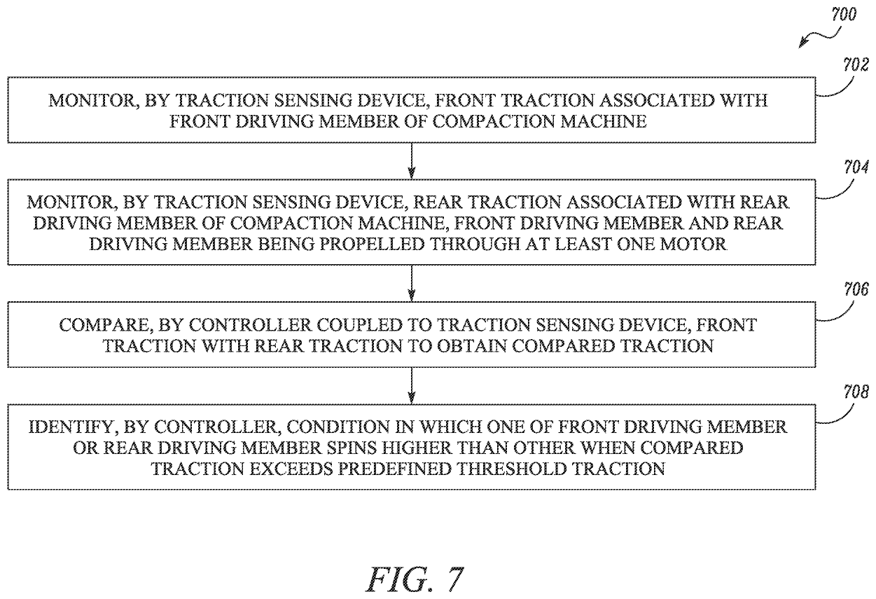

Referring to FIG. 7, a method for operating a compactor drum 120 of a compaction machine 100 is discussed. Said method is illustrated and discussed by way of a flowchart 700, as is shown in FIG. 7. Said method is discussed also in conjunction with FIGS. 1-6 and may be understood to also relate to the system 200. The method starts at step 702.

At step 702, the traction sensing device 205 monitors the front traction associated with the front driving member 105 of the compaction machine 100 climbing upon the ram 405 of the trailer 400. The front traction being corresponding to the rotational speed or the hydraulic pressure of the front driving motor 130′ propelling the front driving member 105. The method proceeds to step 704.

At step 704, the traction sensing device 205 monitors the rear traction associated with the rear driving member 110. The rear traction being corresponding to the rotational speed or the hydraulic pressure of the rear driving motor 130″ propelling the rear driving member 110. As described earlier, the traction sensing device 205 includes the speed sensor 215 and/or the pressure sensor 220 configured for monitoring the front driving motor 130′ and the rear driving motor 130″. The method proceeds to step 706.

At step 706, the controller 210, being coupled to the traction sensing device 205, compares the front traction with the rear traction to obtain a compared traction. The traction associated with either the front driving member 105 or the rear driving member 110 is indicative of spinning of the front driving member 105 or the rear driving member 110 relative to the ramp 405. When both the front driving member 105 or the rear driving member 110 are experiencing traction, the controller 210 evaluates the compared traction based upon the rotational speed of motors 130′ and 130″. The method proceeds to step 708.

At step 708, in case, the compared traction is within a predefined threshold traction, the controller 210 does not cause any action to take place on motors 130′ and 130″. Further in an embodiment, the controller 210 is configured to identify a condition in which one of the front driving member 105 or the rear driving member 110 spins higher than the other or is slipping with respect to the other. When either the front driving member 105 or the rear driving member 110 are slipping, the speed of the slipping member increases. In case, the condition is identified, the controller 210 generates an alert signal indicating that the compared traction has exceeded the predefined threshold traction.

As the controller 210 detects that the compared traction has exceeded the predefined threshold traction, and the traction control device 225 is activated, the traction control device 225 lowers the torque applied by the motor 130′ or 130″ to the slipping member until the compared traction comes within the range of predefined threshold traction.

The method and system for operating a compactor drum 120 of a compaction machine 100 provides an effective solution to counter situations of slipping of the compaction machine 100 while loading on to the trailer 400. When compaction machines are loaded on a trailer, depending on the ramp material, the drums or the tires can spin and often slide which can cause undesirable conditions. The method and system explained in the foregoing specification generates an alert signal to intimate or notify the operator about the condition of the compaction machine and take corrective action. Alternatively, the method and system may initiate the corrective action with or without any intimation to the operator, or in case the operator fails to respond to the alert signal within a predefined time.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A method for operating a compaction machine, the method comprising:
monitoring, by a traction sensing device, a front traction associated with a front driving member of the compaction machine;
monitoring, by the traction sensing device, a rear traction associated with a rear driving member of the compaction machine, the front driving member and the rear driving member being propelled through at least one motor;
comparing, by a controller coupled to the traction sensing device, the front traction with the rear traction to obtain a compared traction; and
identifying, by the controller, a condition in which one of the front driving member or the rear driving member spins higher than the other when the compared traction exceeds a predefined threshold traction.

2. The method of claim 1 comprising:
generating, by the controller, an alert signal indicative of the condition.

3. The method of claim 2 comprising:
controlling, by a traction control device, traction associated with at least one of the front driving member and the rear driving member based upon the alert signal, wherein the traction control device is configured for selectively and independently controlling the at least one motor, whereby the front traction and the rear traction are controlled to be within threshold traction parameters or a predetermined ratio of each other or a predetermined difference of each other.

4. The method of claim 3, wherein the traction sensing device monitors the front traction and the rear traction through at least one speed sensor configured for monitoring rotational speed of the at least one motor.

5. The method of claim 3, wherein the traction sensing device monitors the front traction and the rear traction through at least one pressure sensor configured for monitoring hydraulic pressure of a hydraulic circuit for propelling the compaction machine, the hydraulic circuit being associated with the at least one motor.

6. The method of claim 5, wherein the at least one pressure sensor is installed in supply and return hydraulic lines of the at least one motor.

7. The method of claim 3, wherein the controller is configured to activate the traction control device in response to the alert signal.

8. The method of claim 4, wherein the traction control device reduces a stroke associated with the at least one motor to control the rotational speed of at the least one motor to regain traction.

9. The method of claim 5, wherein the traction control device controls a flow divider associated with the hydraulic circuit, the flow divider being configured to divert hydraulic fluid flow among the at least one motor to control the rotational speed of at the least one motor to regain traction.

10. A system for operating a compaction machine, the system comprising:
a traction sensing device configured to monitor a front traction associated with front driving member and a rear traction associated with a rear driving member of the compaction machine, the front driving member and the rear driving member being propelled through at least one motor; and
a controller coupled to the traction sensing device, the controller configured to:
compare the front traction with the rear traction to obtain a compared traction, and
identify a condition in which one of the front driving member or the rear driving member spins higher than the other when the compared traction exceeds a predefined threshold traction.

11. The system of claim 10 comprising:
a traction control device for controlling traction associated with at least one of the front driving member and the rear driving member based upon an alert signal generated by the controller, wherein the traction control device is configured for selectively and independently controlling the at least one motor, whereby the front traction and the rear traction are controlled to be within threshold traction parameters or a predetermined ratio of each other or a predetermined difference of each other.

12. The system of claim 11, wherein the traction sensing device includes at least one speed sensor configured for monitoring rotational speed of the at least one motor.

13. The system of claim 11, wherein the traction sensing device monitors the front traction and the rear traction through at least one pressure sensor configured for monitoring hydraulic pressure of a hydraulic circuit for propelling the compaction machine, the hydraulic circuit being associated with the at least one motor.

14. The system of claim 11, wherein, through the alert signal, the controller is configured to activate the traction control device.

15. The system of claim 12, wherein the traction control device reduces a stroke associated with the at least one motor to control the rotational speed of at the least one motor to regain traction.

16. The system of claim 13, wherein the traction control device controls a flow divider associated with the hydraulic circuit, the flow divider being configured to divert hydraulic fluid flow among the at least one motor to control the rotational speed of at the least one motor to regain traction.

17. A compaction machine, comprising:
a front driving member and a rear driving member;
a traction sensing device configured to monitor a front traction associated with the front driving member and a rear traction associated with the rear driving member of the compaction machine, the front driving member and the rear driving member being propelled through at least one motor; and
a controller coupled to the traction sensing device, the controller configured to:
compare the front traction with the rear traction to obtain a compared traction, and
identify a condition in which one of the front driving member or the rear driving member spins higher than the other when the compared traction exceeds a predefined threshold traction.

18. The compaction machine of claim 17 comprising:
a traction control device for controlling traction associated with at least one of the front driving member and the rear driving based upon receiving an alert signal from the controller, wherein the traction control device is configured for selectively and independently controlling the at least one motor, whereby the front traction and the rear traction are controlled to be within threshold traction parameters or a predetermined ratio of each other or a predetermined difference of each other.

19. The compaction machine of claim 17, wherein the front driving member is a steel drum and the rear driving member is one of a tire or a steel drum.

20. The compaction machine of claim 18, wherein the traction control device reduces a stroke associated with the at least one motor to control the rotational speed of at the least one motor to regain traction; or controls a flow divider associated with the hydraulic circuit, the flow divider being configured to divert hydraulic fluid flow among the at least one motor to control the rotational speed of at the least one motor to regain traction.
